(19) United States
(12) Patent Application Publication
(10) Pub. No.: US 2021/0245548 A1
(43) Pub. Date: Aug. 12, 2021

(54) Pneumatic Tire for a Vehicle

(71) Applicant: Continental Reifen Deutschland GmbH, Hannover (DE)

(72) Inventors: Tiago Moura, Hannover (DE); Thomas Kramer, Herford (DE); Michael Schunack, Hannover (DE)

(73) Assignee: Continental Reifen Deutschland GmbH, Hannover (DE)

(21) Appl. No.: 17/262,334

(22) PCT Filed: Jul. 29, 2019
(86) PCT No.: PCT/EP2019/070299

§ 371 Date: Jan. 22, 2021

(30) Foreign Application Priority Data
Aug. 16, 2018 (DE) 10 2018 213 795.1

(51) Int. Cl. B60C 9/20; B60C 9/00

(52) U.S. Cl. CPC B60C 9/2006; D07B 1/062; B60C 9/0007

(57) ABSTRACT

Pneumatic vehicle tire of radial type of construction, in particular a commercial vehicle tire, having a belt assembly (3) made up of at least three plies (8, 9, 10), namely two working plies (8, 9) and a protective ply (10) arranged radially on the outside with respect to the working plies (8, 9), wherein the protective ply (10) has reinforcing members (11) made up of one or more twisted-together steel filaments (12), wherein the steel of the steel filaments (12) of the reinforcing members (11) of the protective ply (10) can be assigned to the strength class ST or to a higher strength class, wherein the strength class ST has a tensile strength in MPa of 3980-2000 d and the strength class UT has a tensile strength in MPa of 4400-2000 d, wherein d is the diameter of a steel filament in mm.

The invention relates to a pneumatic vehicle tire of radial type of construction, in particular a commercial vehicle tire, having a belt assembly made up of at least three plies, namely two working plies and a protective ply arranged radially on the outside with respect to the working plies, wherein the protective ply has reinforcing members made up of one or more twisted-together steel filaments, wherein the steel of the steel filaments can be assigned to a strength class.

Commercial vehicle tires having a belt that has two working plies and a protective ply are known to a person skilled in the art.

Usually, the belt of commercial vehicle tires has four plies, which consist of steel cords embedded in rubber compounds. In a 4-ply belt, the radially innermost ply is designated the “1st belt ply” or, depending on its function, the “barrier ply”. Arranged radially on the outside of the latter are the 2nd belt ply and the 3rd belt ply acting as what are known as “working plies”. The radially outer working ply is covered by the 4th belt ply, known as the “cover ply” or “protective ply”.

The steel cords of the 1st belt ply generally exhibit an angle of >45° with respect to the circumferential direction. The 1st belt ply, on account of its function of preventing the working plies from being able to move in the circumferential direction, is referred to as the “barrier ply”. The steel cords of the two working plies typically exhibit an identical angle of between 15° and 30° with respect to the tire circumferential direction, wherein the steel cords of one working ply are inclined in the opposite direction to the steel cords of the other working ply with respect to the tire circumferential direction. Thus, the steel cords of one working ply are arranged so as to cross the steel cords of the other working ply. The working plies are subjected to high shear and tensile forces, bear the main load in the belt and are therefore of particular significance for belt durability.

The 4th belt ply has the function of a protective ply for the two working plies located therebeneath, in that it represents a barrier for stones or other objects that could penetrate the tread assembly. Without the protective ply, the cords of the working plies would be damaged much more often by penetrating stones and be subject to increased corrosion, and this would ultimately reduce the load capacity, the durability and the retread capacity of the tire, inasmuch as the tire is able to be retreaded.

The term “commercial vehicle tire” also covers what are known as “off the road” tires, which are used for example for building sites, non-asphalted roads or mine sites.

The steel filaments consist of steel of a particular strength class. The assignment to a strength class on the basis of the classification published by the company NV Bekaert SA and listed below:

| Strength | Tensile |
|---|---|
| class | strength (MPa) |
| NT | 3250-2000*d |
| HT | 3800-2000*d |
| ST | 3980-2000*d |
| UT | 4400-2000*d |

d = filament diameter in mm

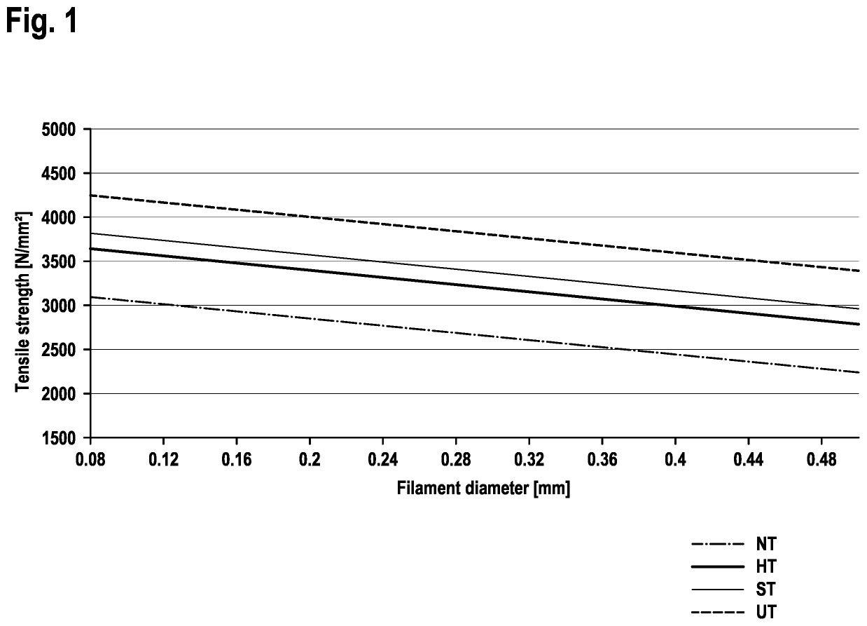

Moreover, the diagram in FIG. 1 shows the relationship between tensile strength and filament diameter of each of the four above-mentioned steel strength classes. It is apparent that the tensile strength (force per unit area) increases with a smaller diameter.

For example, it is known practice to use steel cords of the construction 3×0.20+6×0.35 of the strength class HT for the protective ply. This above-mentioned steel cord has a core strand made of three twisted-together steel filaments with a diameter of 0.20 mm, which are surrounded by six filaments with a diameter of 0.35 mm.

Furthermore, it is known practice to use steel cords of the construction 1×0.40+5×0.40 for the protective ply. This steel cord has a core filament with a diameter of 0.40 mm, which is surrounded by five filaments with a diameter of 0.40 mm. The steel filaments can likewise be assigned to the strength class HT. This results in a cord diameter of 1.20 mm and, as rubberized ply, a thickness of between about 1.60 mm and 2.50 mm. These cords are arranged in the protective ply at a density of 30 to 60 ends per decimeter (epdm).

It is possible for reinforcing members of the protective ply to break upon trapping stones, or for stones or other objects to penetrate as far as the working plies, with the result that the durability of the vehicle tire and the retreading capacity of the latter can be reduced.

Efforts are constantly being made to improve pneumatic vehicle tires in terms of their durability and, if additionally possible, to lower the weight and production costs thereof.

The invention accordingly addresses the problem of designing a commercial vehicle tire of the type mentioned at the beginning with an at least three-ply belt assembly in such a way that its durability is improved.

The problem is solved according to the invention in that the steel of the steel filaments of the reinforcing members of the protective ply can be assigned to the strength class ST or to a higher strength class, wherein the strength class ST has a tensile strength in MPa of 3980-2000*d and the strength class UT has a tensile strength in MPa of 4400-2000*d, wherein d is the diameter of a steel filament in millimeters.

A commercial vehicle tire having an at least three-ply belt has been created, the protective ply of which has been improved in terms of its function of “protecting” the plies arranged therebeneath with respect to penetrating stones or other objects by “trapping” these stones or other objects.

The steel reinforcing members of the protective ply of the tire according to the invention can be assigned to the strength class ST or higher. Tests have shown that comparable steel reinforcing members of the strength class ST can absorb approximately 11% more energy compared with the strength class HT and are thus much more durable in use in the protective ply and are less inclined to reinforcing member breakages.

It is expedient if the reinforcing members of the protective ply are steel cords of the construction 1+N, where N=4 or 5, preferably where N=5.

It is advantageous if the reinforcing members are arranged in the protective ply at a density of 20 to 90 epdm, preferably at a density of 25 to 75 epdm, particularly preferably at a density of 30 to 70 epdm. This results in the best compromise between tire durability and tire rolling resistance.

It is expedient if each steel filament of the reinforcing member of the protective ply has the same filament diameter, wherein the diameter lies in a range from 0.30 to 0.45 mm, preferably in a range from 0.32 to 0.40 mm, particularly preferably in a range from 0.32 to 0.35 mm. This results in the best compromise between tire durability and tire rolling resistance.

It is advantageous if each steel filament of the reinforcing member of the protective ply has the same filament diameter, wherein the steel filament having a filament diameter in a range from 0.30 to 0.45 mm has a breaking strength in a range from 235 to 560 N, wherein the steel filament having a filament diameter in the preferred from 0.32 to 0.40 mm has a breaking strength in a range from 265 to 455 N, and wherein the steel filament having a filament diameter in the particularly preferred range from 0.32 to 0.35 mm has a breaking strength in a range from 265 to 360 N. The following table shows the above-described ranges of the filament diameters in millimeters and the associated ranges of the breaking force in N. This results in the best compromise between tire durability and tire rolling resistance.

TABLE

| Filament | Breaking |
|---|---|
| diameter | strength of the |
| (mm) | filament (N) |
| 0.30-0.45 | 235-560 |
| 0.32-0.40 | 265-455 |
| 0.32-0.35 | 265-360 |

In a preferred embodiment of the invention, the reinforcing members of the protective ply are cords of the construction 1×0.35 ST+5×0.35 ST or cords of the construction 1×0.32 ST+5×0.32 ST, which are arranged in the protective ply preferably at a density of between 20 and 90 ends per decimeter (epdm).

The cord of the construction 1×0.32 ST+5×0.32 ST has a comparatively only very small diameter of 0.96 mm. In spite of this small diameter, the absorbed energy is at least the same as or greater than that of a thicker cord of a lower steel strength class, for example of the construction 1×0.40 HT+5×0.40 HT with a cord diameter of 1.2 mm. As a result of the use of reinforcing members with a smaller diameter, the ply thickness of the protective ply can be reduced, with the result that the costs and weight of the tire are maintained while having the same or greater strength.

On the other hand, it is possible to embody known cord constructions of the protective ply with steel of the strength class ST or higher, with the result that a protective ply that better prevents stone penetration and cord breakages is obtained.

Further features, advantages and details of the invention will now be described in more detail on the basis of the drawings, which illustrate a schematic exemplary embodiment. In the drawings,

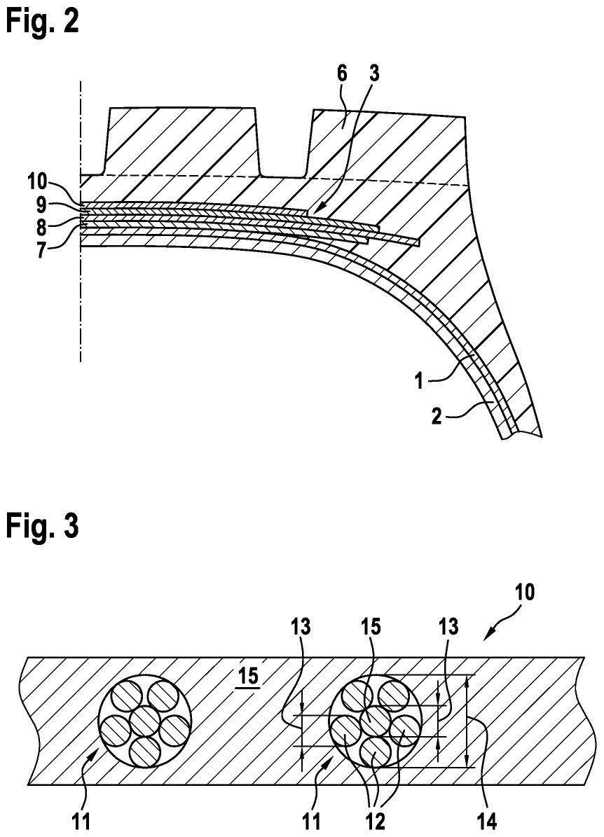

FIG. 2 shows a partial cross section through one half of a pneumatic vehicle tire in the region of the belt and of the tread;

FIG. 3 shows a cross section through a steel cord of the protective ply of the tire in FIG. 2.

FIG. 2 shows a cross section through the tread and the belt region of a pneumatic vehicle tire for trucks having a conventional standard construction with a carcass 1 having steel cords as reinforcing members, an airtight inner layer 2, a multi-ply belt assembly 3, and a profiled tread 6.

The belt assembly 3 has four belt plies 7, 8, 9 and 10, wherein the fourth, radially outermost belt ply has the smallest width of all the plies and forms what is known as the protective ply 10. The first belt ply is what is known as the barrier ply 7, the second belt ply and the third belt ply are what are known as the working plies 8, 9. The widest belt ply is the second belt ply 8, which accordingly completely covers the first belt ply 7. The third belt ply 9 is somewhat wider than or the same width as the first belt ply 7. The fourth belt ply 10 can furthermore be embodied with the same width as the third belt ply 9. All of the belt plies 7, 8, 9, 10 consist of reinforcing members that are embedded in a rubber compound, the belt rubber coating, and consist of steel cord, wherein the steel cords are arranged parallel to one another and in a manner spaced apart from one another.

FIG. 3 shows a cross section through the protective ply 10 of the tire in FIG. 2. The protective ply 10 has steel cords 11 of the strength class ST, which are embedded in a rubber compound 15. The steel cords 11 are arranged parallel to one another and in a manner spaced apart from one another in this protective ply 10. The steel cords 11 have the construction 1×0.32 ST+5×0.32 ST, meaning that each steel cord 11 has a core filament 15 with a diameter 13 of 0.32 mm, which is surrounded by five filaments with a diameter of 0.32 mm. The cord diameter 14 is 0.96 mm. The reinforcing members 11 are arranged in the protective ply 10 at a density in a range of 30-70 ends per decimeter (epdm).

### LIST OF REFERENCE SIGNS

### Part of the Description

1 Carcass
2 Inner layer
3 Belt assembly
6 Tread
7 Barrier ply (1st belt ply)
8 Working ply (2nd belt ply)
9 Working ply (3rd belt ply)
10 Protective ply (4th belt ply)
11 Reinforcing member/steel cord
12 Steel filament
13 Filament diameter
14 Cord diameter
15 Core filament

1.-6. (canceled)

7. A pneumatic vehicle tire of radial type of construction, in particular a commercial vehicle tire, having a belt assembly comprising at least three plies, wherein the at least three plies comprise two working plies and a protective ply arranged radially on the outside with respect to the working plies, wherein the protective ply has reinforcing members made up of one or more twisted-together steel filaments, and wherein the steel of the steel filaments can be assigned to a strength class;
wherein steel of the steel filaments of the reinforcing members of the protective ply are assigned to the strength class ST or to a higher strength class, wherein the strength class ST has a tensile strength in MPa of 3980-2000*d and the strength class UT has a tensile strength in MPa of 4400-2000*d, wherein d is the diameter of a steel filament in millimeters; and,
wherein the reinforcing members of the protective ply are steel cords of the construction 1+5×0.35 ST or cords of the construction 1+5×0.32 ST, which are arranged in the protective ply at a density of between 30 and 90 ends per decimeter (epdm).

8. The pneumatic vehicle tire as claimed in claim 7, wherein the reinforcing members of the protective ply are steel cords of the construction 1+N, where N=4 or 5.

9. The pneumatic vehicle tire as claimed in claim 7, wherein the reinforcing members are arranged in the protective ply at a density of 20 to 90 epdm.

10. The pneumatic vehicle tire as claimed in claim 7, wherein each steel filament of the reinforcing member of the protective ply has the same filament diameter, and wherein the diameter lies in a range from 0.30 to 0.45 mm.

11. The pneumatic vehicle tire as claimed in claim 7, wherein each steel filament of the reinforcing member of the protective ply has the same filament diameter, wherein the steel filament having a filament diameter in a range from 0.30 to 0.45 mm has a breaking strength in a range from 235 to 560 N, wherein the steel filament having a filament diameter in a range from 0.32 to 0.40 mm has a breaking strength in a range from 265 to 455 N, and wherein the steel filament having a filament diameter in the range from 0.32 to 0.35 mm has a breaking strength in a range from 265 to 360 N.
